(19) United States
(12) Patent Application Publication
(10) Pub. No.: US 2026/0029131 A1
(43) Pub. Date: Jan. 29, 2026

(54) COOKTOP APPLIANCE TEMPERATURE-BASED FAN CONTROL

(71) Applicant: Haier US Appliance Solutions, Inc., Wilmington, DE (US)

(72) Inventor: Jennifer Lea Alford, Louisville, KY (US)

(21) Appl. No.: 18/785,747

(22) Filed: Jul. 26, 2024

(51) Int. Cl. F24C 7/08; F24C 15/00; H05B 6/12

(52) U.S. Cl. CPC F24C 7/081; F24C 15/006; H05B 6/1263

(57) ABSTRACT

An induction cooking appliance includes a cooktop that includes a heating element. The heating element includes an induction coil. The induction cooking appliance also includes a cooling fan, a temperature sensor, and a controller in communication with the temperature sensor. A method of operating the induction cooking appliance includes the controller performing a cooking operation. The cooking operation includes activating the heating element of the induction cooking appliance. The method also includes monitoring a temperature with the temperature sensor during the cooking operation. The method further includes operating the cooling fan based on the monitored temperature of the temperature sensor.

### FIELD OF THE INVENTION

The present subject matter relates generally to cooking appliances with induction heating systems, and more particularly to controlling fans of the induction heating systems.

### BACKGROUND OF THE INVENTION

Cooktop appliances generally include heating elements for heating cooking utensils, such as pots, pans, and griddles. A variety of configurations may be used for the heating elements located on the cooking surface of the cooktop. The number of heating elements or positions available for heating on the range appliance may include, for example, four, six, or more depending upon the intended application and preferences of a consumer. The heating elements of the cooktop appliance may vary in size, location, and capability across the appliance.

One such configuration may include induction heating elements. Typical induction cooking appliances heat conductive cookware by magnetic induction. An induction cooking appliance may apply radio frequency current to an induction heating coil to generate a radio frequency magnetic field on the heating coil. When a conductive vessel, such as a pan, is placed over the heating coil, the magnetic field from the heating coil may generate eddy currents within the vessel, causing the vessel to increase in temperature. However, generating the magnetic field on the heating coil raises internal temperatures of the internal components, which may be cooled by operating fan(s) within the induction heating element. Operating the induction heating coil in addition to operating fan(s) may consume an undesirable amount of power. However, reducing energy consumption while the cooktop is on may impact cooking performance.

As a result, it would be advantageous to have an appliance or method to cool the internal temperatures of the induction switching devices, when the induction heating elements are in use, using less power than the traditional appliances and methods, without compromising cooking performance.

### BRIEF DESCRIPTION OF THE INVENTION

Aspects and advantages of embodiments of the present disclosure will be set forth in part in the following description, or may be learned from the description, or may be learned through practice of the embodiments.

In one example embodiment a method of operating an induction cooking appliance is provided. The induction cooking appliance includes a cooktop that includes a heating element. The heating element includes an induction coil. The induction cooking appliance also includes a cooling fan, a temperature sensor, and a controller in communication with the temperature sensor. The method of operating the induction cooking appliance includes the controller performing a cooking operation. The cooking operation includes activating the heating element of the induction cooking appliance. The method also includes monitoring a temperature with the temperature sensor during the cooking operation. The method further includes operating the induction cooling fan based on the monitored temperature of the temperature sensor.

In another example embodiment an induction cooking appliance is provided. The induction cooking appliance includes a cooktop that includes a heating element. The heating element includes an induction coil. The induction cooking appliance also includes a cooling fan, a temperature sensor, and a controller in communication with the temperature sensor. The controller is configured to perform a cooking operation. The cooking operation includes activating the heating element of the induction cooking appliance. The controller is also configured to monitor a temperature with the temperature sensor during the cooking operation. The controller is further configured to operate the induction cooling fan based on the monitored temperature of the temperature sensor.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 illustrates a perspective view of an example induction cooking appliance according to example embodiments of the present disclosure.

FIG. 2 depicts a block diagram of an example induction heating system of the example induction cooking appliance of FIG. 1, according to example embodiments of the present disclosure.

FIG. 3 provides a perspective view of an example induction tray of the example induction cooking appliance of FIG. 1, according to example embodiments of the present disclosure.

FIG. 4 illustrates a flow diagram of an example method of operating an induction cooking appliance according to aspects of the present disclosure.

Repeat use of reference characters in the present specification and drawings is intended to represent the same and/or analogous features or elements of the present invention.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations may be made to the embodiments without departing from the scope or spirit of the present disclosure. For instance, features illustrated or described as part of one embodiment may be used with another embodiment to yield a still further embodiment. Thus, it is intended that aspects of the present disclosure cover such modifications and variations.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (e.g., “A or B” is intended to mean “A or B or both”). The term “at least one of” in the context of, e.g., “at least one of A, B, and C” refers to only A, only B, only C, or any combination of A, B, and C. In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “example” is used herein to mean “serving as an example, instance, or illustration.” In addition, references to “an embodiment” or “one embodiment” does not necessarily refer to the same embodiment, although it may. Any implementation described herein as “exemplary,” “example,” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations may be made in the present invention without departing from the scope of the invention. For instance, features illustrated or described as part of one embodiment may be used with another embodiment to yield a still further embodiment. Thus, it is intended that the present invention covers such modifications and variations as come within the scope of the appended claims and their equivalents.

The terms “coupled,” “fixed,” “attached to,” and the like refer to both direct coupling, fixing, or attaching, as well as indirect coupling, fixing, or attaching through one or more intermediate components or features, unless otherwise specified herein.

Except as explicitly indicated otherwise, recitation of a singular processing element (e.g., “a controller,” “a processor,” “a microprocessor,” etc.) is understood to include more than one processing element. In other words, “a processing element” is generally understood as “one or more processing element.” Furthermore, barring a specific statement to the contrary, any steps or functions recited as being performed by “the processing element” or “said processing element” are generally understood to be capable of being performed by “any one of the one or more processing elements.” Thus, a first step or function performed by “the processing element” may be performed by “any one of the one or more processing elements,” and a second step or function performed by “the processing element” may be performed by “any one of the one or more processing elements and not necessarily by the same one of the one or more processing elements by which the first step or function is performed.” Moreover, it is understood that recitation of “the processing element” or “said processing element” performing a plurality of steps or functions does not require that at least one discrete processing element be capable of performing each one of the plurality of steps or functions.

In general, induction cooking appliances may have induction heating systems configured to heat a load (e.g., a pan, cookware, vessel, etc.). The induction heating system may include one or more coils (e.g., induction coils) operable to inductively heat one or more loads with a magnetic field and an inverter system operable to supply alternating current through the coil. Induction coil parameters such as the current passing through the coil are important in deciding a variety of operational characteristics/states of the induction heating system. For example, induction coil parameters may be used to determine an output power of the induction coil or if a load is present on a coil of the induction cooking appliance.

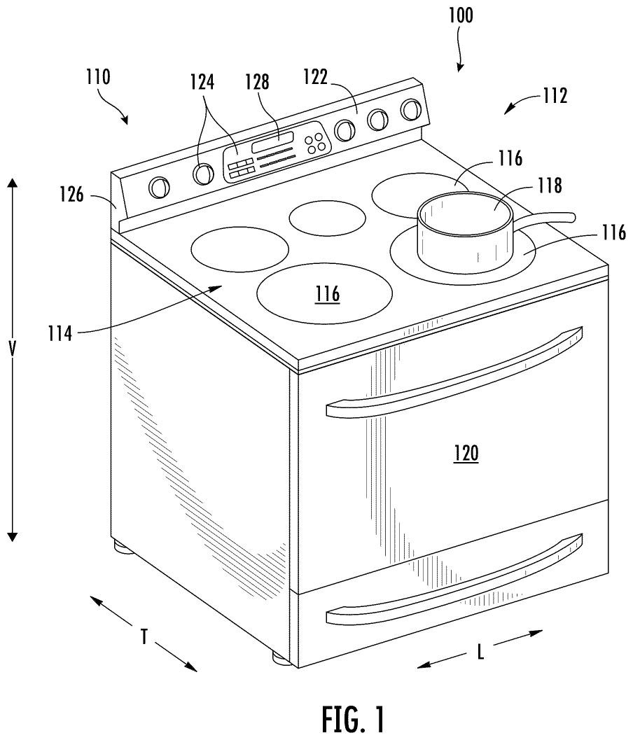

FIG. 1 depicts a perspective view of an induction cooking appliance 100. The induction cooking appliance include a cooktop 112, such as an induction cooktop. Induction cooking appliance 100 is provided by way of example only and is not intended to limit the present subject matter to the arrangement shown in FIG. 1. Thus, the present subject matter may be used with other induction cooking appliances such as oven appliances, single oven range appliances, double oven range appliances, standalone cooktop appliances, cooktop appliances without an oven, etc.

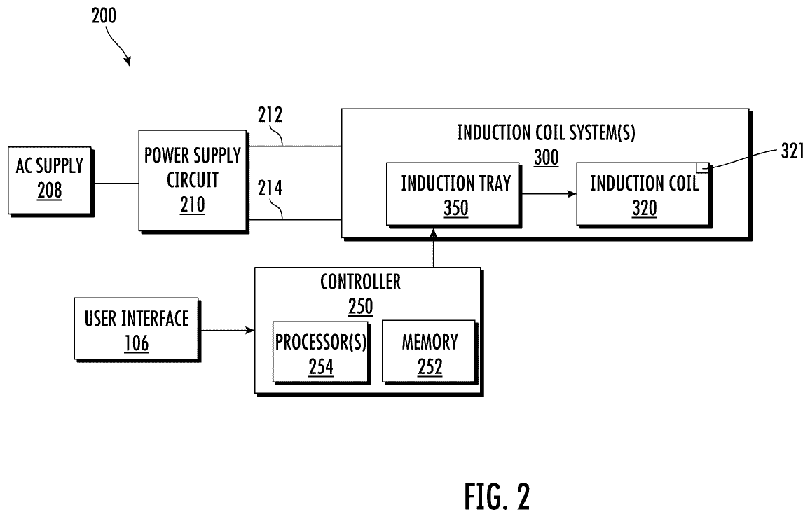

A cooking surface 114 of cooktop 112 includes one or more heating elements 116, such as induction heating elements. As shown in FIG. 1, cooktop 112 may include a plurality of heating elements 116. The heating elements 116 may be generally positioned at, e.g., on or proximate/adjacent to, a cooking surface 114 of cooktop 112. In some example embodiments, such as the illustrated embodiment, cooktop 112 may include five (5) heating elements 116 spaced along cooking surface 114. However, in other embodiments, cooktop 112 may include any other suitable shape, configuration, and/or number of heating elements 116. In general, each of the heating elements 116 may be induction heating elements 116, or cooktop 112 may include a combination of different types of heating elements 116. For example, in some example embodiments, cooktop 112 may include any other suitable type of heating element(s) 116 in addition to the induction heating element, such as a resistive heating element or gas burners, etc. In general, induction heating elements 116 may be part of an induction coil system 300 (FIG. 2), as will be described further below.

As shown in FIG. 1, a load 118 (e.g., cooking vessel), such as a pot, pan, or the like, may be placed on one of heating element(s) 116 in order to heat the load 118 and cook/heat food items placed in/on load 118. Induction cooking appliance 100 may also include a door 120 that permits access to a cooking chamber (not shown) of induction cooking appliance 100, e.g., for cooking or baking of food items therein. Induction cooking appliance 100 may also include a user interface 110. User interface 110 may generally include a control panel 122 having controls 124 (e.g., user input devices), which may permit a user to make selections for cooking of food items. Although shown on a backsplash or back panel 126 of induction cooking appliance 100, control panel 122 may be positioned in any suitable location. Controls 124 may include buttons, knobs, and the like, as well as combinations thereof, and/or controls 124 may be implemented on a remote user interface device such as a smartphone, tablet, etc. As an example, a user may manipulate one or more controls 124 to select a temperature and/or a heat (or power output) for each heating element 116. The selected temperature or heat output of heating element 116 affects the heat transferred to load 118 placed on heating element 116. In general, user interface 110 may also include a display 128 configured to display information relating to the selected temperature or time.

In general, induction cooking appliance 100 includes a control system for controlling one or more of the plurality of heating elements 116. The control system may generally include a controller 250 (FIG. 2) operably coupled to the control panel 122 and the controls 124 and display 128 thereof. The controller may also be operably coupled to each of the plurality of heating elements 116 for controlling a heating level each of the plurality of heating elements 116 in response to one or more user inputs received through the control panel 122 and controls 124. The controller may also provide output to the display 128, such as an indication of a selected power level, which heating element(s) 116 is or are activated, etc. Furthermore, as will be discussed in greater detail below, the controller may further be configured to control operation of an induction heating system 200 (FIG. 2) of the induction cooking appliance 100.

Referring now to FIG. 2, a block diagram of an induction heating system 200 for an induction cooking appliance is provided. While induction heating system 200 is discussed with reference to induction cooking appliance 100 of FIG. 1, those of ordinary skill in the art will understand that induction heating system 200 may be used in any suitable cooking system without deviating from the scope of the present disclosure.

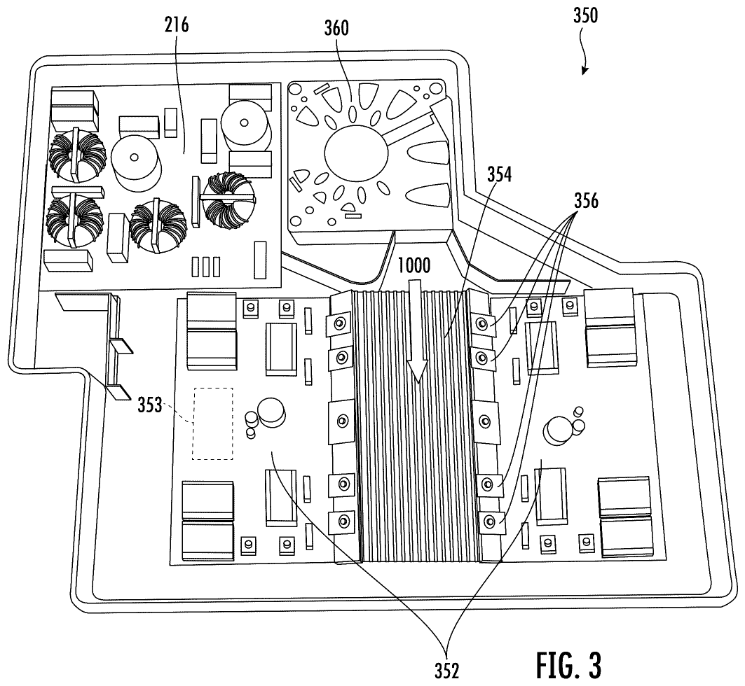

Induction heating system 200 generally includes a power supply circuit 210. Power supply circuit 210 may receive AC power from an AC supply 208, which may provide conventional sixty Hertz (60 Hz), two hundred and eight volt (208V) or two hundred and forty volt (240V) AC supplied by utility companies. Power supply circuit 210 may include rectification circuitry for rectifying the power signal from the AC supply 208. In addition, power supply circuit 210 may include filtering and power factor correction circuitry, such as filter board 216 (FIG. 3) to filter the rectified power signal. In some embodiments, AC supply 208 and/or power supply circuit 210 may be configured to provide AC power to multiple induction coils 320.

Induction heating system 200 further includes an induction coil system 300 operable to inductively heat a load with an induction coil 320, e.g., an induction coil 320 may be positioned at each heating element 116. In general, induction coil system 300 may include an inverter system and may be operatively coupled to power supply circuit 210 by a high-side path 212 and a low-side path 214. In some embodiments, high-side path 212 may be defined by a bus voltage, which is supplied to induction coil system 300 by power supply circuit 210. Low-side path 214 may be defined by a ground supplied to low-side path 214 by power supply circuit 210.

Induction coil system 300 includes induction coil(s) 320 and an inverter system (not shown), such as a resonant inverter system. In general, induction coil(s) 320, when supplied with an alternating current by inverter system, may inductively heat cookware (e.g., pan, cooking vessel), such as load 118, or other object placed on, over, or near induction coil(s) 320. It will be understood that use of the term “load” herein is used merely as an example, and that term will generally include any object of a suitable type that is capable of being heated by an induction heating coil.

In some embodiments, induction heating system 200 may be coupled to controller 250. Controller 250 may include memory 252 and one or more processors 254 such as microprocessors, CPUs or the like, such as general or special purpose microprocessors operable to execute programming instructions or micro-control code associated with operation of induction cooking appliance 100. Memory 252 may represent random access memory such as DRAM, or read only memory such as ROM or FLASH. In one embodiment, processor 254 may execute programming instructions stored in memory 252. Memory 252 may be a separate component from controller 250 or may be included onboard controller 250. In some embodiments, controller 250 may be operatively coupled to user interface 110.

For example, controller 250 may be operable to execute programming instructions or micro-control code associated with an operation of induction cooking appliance 100. In this regard, the instructions may be software or any set of instructions that when executed by the processing device, cause the processing device to perform operations, such as running one or more software applications, displaying a user interface, receiving user input, processing user input, etc. Moreover, it should be noted that controller 250 as disclosed herein is capable of and may be operable to perform any methods, method steps, or portions of methods as disclosed herein. For example, in some embodiments, methods disclosed herein may be embodied in programming instructions stored in the memory and executed by controller 250.

In general, controller 250 may be operatively coupled to induction coil system 300. Controller 250 may be configured to control the power of the induction coil 320 by controlling the switching frequency of the inverter system. For example, controller 250 may include a microcontroller and/or gate driver to drive individual transistors or switching devices of the induction coil system 300 (e.g., inverter system of induction coil system 300) with pulse-width modulated signals. In general, induction coil system 300 may include a switching device 356 (FIG. 3). Induction coil 320 may be coupled between a high-side switching device and a low-side switching device, e.g., switching devices provide alternating current to the induction coil 320 at a desired frequency. For example, the switching devices may be Insulated-Gate Bipolar Transistors (IGBTs).

FIG. 3 provides a perspective view of an induction tray 350 according to example embodiments of the present disclosure. In general, induction tray 350 may house various components in operable communication with induction coil 320 of heating element 116. In particular, induction tray 350 may include one or more generator boards 352, a heat sink 354, switching devices 356, and an induction cooling fan 360. In general, generator board 352 and induction coil 320 generate the magnetic field which inductively heats load 118. More specifically, switching devices 356, e.g., IGBTs, may be in operable communication with generator board 352 and may provide control and conversion of electrical circuits to wirelessly transfer electrical energy by induction to load 118. For example, controller 250, generator board 352, and switching devices 356 may be coupled to heat sink 354 in order to monitor and control the temperature of switching devices 356.

In general, cooling fan 360 may be positioned within induction tray 350 proximate to, e.g., adjacent to, or within five centimeters of, heat sink 354. In general, cooling fan 360 may be configured to force airflow, such as illustrated airflow 1000, over heat sink 354 of the heating element 116. As such, cooling fan 360 may be operable to reduce the temperature of components, such as the switching devices, e.g., IGBTs, within induction tray 350. In particular, controller 250 may include, or be in communication with, a temperature sensor 353 configured to measure a temperature value within induction tray 350, e.g., controller 250 may be positioned within induction tray 350, or temperature sensor 353 may be positioned within induction tray 350, such as positioned on the generator board(s) 352. As such, temperature sensor 353 may be built-in to controller 250, built into generator board(s) 352, or may be a stand-alone temperature sensor. The temperature value measured by temperature sensor 353 may be correlated with the temperature of the switching devices 356, i.e., the insulated-gate bipolar transistors, since both generator boards 352 and switching devices 356 are coupled to heat sink 354. In some example embodiments, a second temperature sensor 321 (FIG. 2) may be positioned within the induction coil system 300, e.g., second temperature sensor 321 may be positioned on induction coil 320 of heating element 116, such as beneath cooking surface 114. In general, second temperature sensor 321 may measure the temperature of induction coil 320.

As used herein, “temperature sensor” or the equivalent is intended to refer to any suitable type of temperature measuring system or device positioned at any suitable location for measuring the desired temperature. Thus, for example, temperature sensors 321 and 353 may each be any suitable type of temperature sensor, such as a thermistor, a thermocouple, a resistance temperature detector, a semiconductor-based integrated circuit temperature sensor, etc. In addition, each temperature sensor 321 and/or 353 may be positioned at any suitable location and may output a signal, such as a voltage, to a controller, such as controller 250, that is proportional to and/or indicative of the temperature being measured. Although example positioning of temperature sensors is described herein, it should be appreciated that induction cooking appliance 100 may include any other suitable number, type, and position of temperature and/or other sensors according to alternative embodiments.

In general, while induction coil system 300 is described to inductively heat a load with an induction coil, one of skill in the art would understand that a plurality of heating elements, e.g., a plurality of induction coils, may be included in induction coil system 300. Accordingly, one of skill in the art would also understand that controller 250 and generator boards 352 of induction tray 350 may be in operable communication with multiple heating elements, such as two (2) or more.

As one skilled in the art will appreciate, the above described embodiments are used only for the purpose of explanation. Modifications and variations may be applied, other configurations may be used, and the resulting configurations may remain within the scope of the invention. For example, induction cooking appliance 100 is provided by way of example only and aspects of the present subject matter may be incorporated into any other suitable induction cooking appliances.

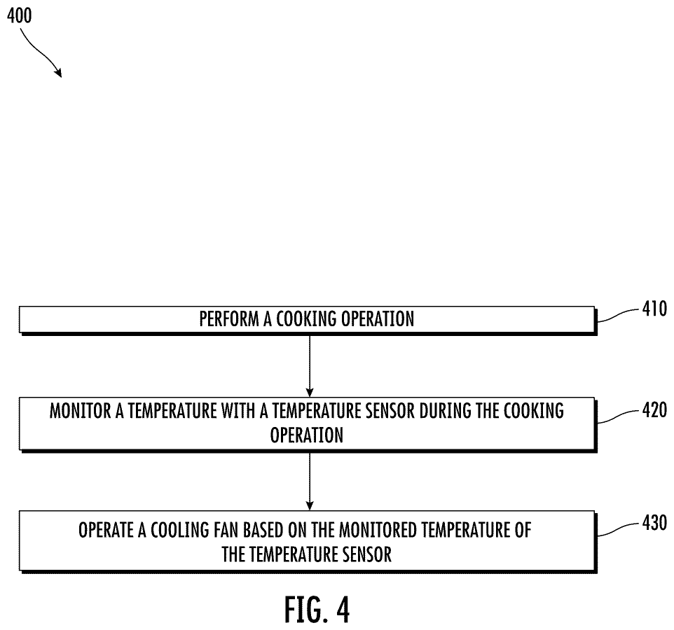

Referring now to FIG. 4, a flow diagram of one embodiment of a method 400 of operating induction cooking appliance 100 is illustrated in accordance with aspects of the present subject matter. In general, method 400 will be described herein with reference to the embodiments of induction cooking appliance 100 and related elements described above with reference to FIGS. 1-3. However, it should be appreciated by those of ordinary skill in the art that the disclosed method 400 may generally be utilized in association with apparatuses and systems having any other suitable configuration. In addition, although FIG. 4 depicts steps performed in a particular order for purposes of illustration and discussion, the method discussed herein is not limited to any particular order or arrangement. One skilled in the art, using the disclosures provided herein, will appreciate that various steps of the method disclosed herein can be omitted, rearranged, combined, and/or adapted in various ways without deviating from the scope of the present disclosure.

As shown in FIG. 4, at (410), method 400 may generally include performing a cooking operation. In general, performing the cooking operation may include activating the heating element 116, such as induction coil 320, of the induction cooking appliance 100 in order to heat/cook food contents, e.g., load 118. For example, the cooking operation may include operating induction coil 320, e.g., turning induction coil 320 ON, at a specified power level to heat load 118. In general, the specified power level may be a range of power between zero percent (0%) and one hundred percent (100%) power, with zero percent (0%) power being induction coil 320 is OFF.

Method 400 may generally include determining an active state condition of the induction coil(s) and a power level condition of the induction coil(s). For example, the active state condition may include determining whether induction coil 320 is one of ON or OFF, and determining the power level condition may include determining induction coil 320 is operating at a specified power level during the cooking operation, such as at eighty percent (80%) power. In some example embodiments, the active state condition may include determining a quantity of induction coils 320 that are ON and may include determining the power level condition of each of the induction coils 320. For example, determining the active state condition of the induction coil(s) and the power level condition of the induction coil(s) may include determining three (3) induction coil(s) are ON and are operating at seventy percent (70%) power level, one hundred percent (100%) power level, and thirty percent (30%) power level, respectively.

At (420), method 400 may generally include monitoring a temperature with a temperature sensor, such as temperature sensor 353 during the cooking operation. In general, built-in temperature sensor 353 may measure the temperature value correlated with the temperature of the switching devices 356, i.e., the insulated-gate bipolar transistors. In general, the monitored temperature value may range between twenty degrees Celsius (20° C.) and one hundred and fifty degrees Celsius (150° C.). In some example embodiments, the second temperature sensor 321 may be positioned on induction coil 320, and method 400 may include monitoring a second temperature with second temperature sensor 321. For example, the temperature monitored with second temperature sensor 321 may be indicative of the temperature of induction coil 320, or more specifically, the temperature of the cooking surface 114 adjacent induction coil 320. In other words, cooking surface 114 may absorb heat from load 118 during the cooking operation.

At (430), method 400 may generally include operating a cooling fan, e.g., cooling fan 360, based on the monitored temperature. In other example embodiments, operating the cooling fan may be based on one or more, such as all three, of the determined active state condition of the induction coil, the determined power level condition of the induction coil, and the monitored temperature. In particular, induction cooling fan 360 may be operated at a specified fan speed determined based on one or more of the determined active state condition of the induction coil, the determined power level condition of the induction coil, and the monitored temperature of the temperature sensor. In particular, cooling fan 360 may operate at various speeds, ranging from a “low” speed to a “high” speed, where the “low” speed is slower than the “high” speed. In some example embodiments, operating the cooling fan 360, or more specifically the specified speed at which cooling fan 360 operates, may be based on the temperature monitored with the second temperature sensor 321.

In general, controller 250 may have various temperature thresholds of temperature values from temperature sensor 353 stored within memory 252. Particularly, a first temperature threshold may be temperature values less than fifty degrees Celsius (50° C.), a second temperature threshold may be approximately between fifty degrees Celsius (50° C.) and ninety degrees Celsius (90° C.), a third temperature threshold may be approximately between ninety degrees Celsius (90° C.) and one hundred and ten degrees Celsius (110° C.) and a fourth threshold of greater than one hundred and ten degrees Celsius (110° C.). One of skill in the art will understand the various temperature thresholds are provided by way of example and explanation only, and the various temperature thresholds presented herein may be any suitable range, ranges, or combination of temperature values.

For example, at (430), method 400 may include operating cooling fan 360 at the “low” speed in response to the monitored temperature from temperature sensor 353 being at the second temperature threshold. Additionally, at (430), method 400 may include operating cooling fan 360 at the “high” speed in response to the monitored temperature from temperature sensor 353 at the third temperature threshold. Furthermore, method 400 may generally include deactivating the cooling fan of the induction cooking appliance 100 in response to the monitored temperature from temperature sensor 353 at the first temperature threshold. Additionally or alternatively, method 400 may include deactivating the heating element of the induction cooking appliance in response to the determined temperature of the temperature sensor being above a threshold temperature value. In particular, method 400 may include deactivating each of the heating element(s) 116 of induction cooking appliance 100 in response to the monitored temperature of temperature sensor 353 being above the fourth threshold temperature value.

Moreover, the determined active state condition of the induction coil(s) and the determined power level condition of the induction coil(s) may be considered by controller 250 when selecting the specified fan speed of induction cooling fan 360. For example, when determining three (3) induction coil(s) are ON and are operating at seventy percent (70%) power level, one hundred percent (100%) power level, and thirty percent (30%) power level, respectively, in addition to the temperature monitored from temperature sensor 353 at the second temperature threshold, the specified fan speed of cooling fan 360 may be the “high” speed. However, in some example embodiments, the specified fan speed may also be selected based on any one of the determined active state condition of the induction coil, the determined power level condition of the induction coil, and the monitored temperature.

As may be seen from the above, a method to reduce usage of a cooling fan in an induction cooking appliance is provided. The cooling fan may blow air across a heat sink to cool electronic components such as insulated-gate bipolar transistor(s). In order to reduce energy consumption when the induction cooking appliance is ON, the control of the cooling fan may be based on the built-in microcontroller temperature sensor that is correlated to the insulated-gate bipolar transistor(s) temperature to determine the operational state, e.g., speed, of the cooling fan. The microcontroller may be installed on the same control board as the insulated-gate bipolar transistor(s) is/are integrated so there may be a direct correlation between the insulated-gate bipolar transistor(s) temperature and the microcontroller temperature. The controller may monitor the built-in microcontroller temperature sensor value to trigger the induction fan to run at a “high” or “low” speed.

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A method of operating an induction cooking appliance, the induction cooking appliance comprising a cooktop, a cooling fan, a temperature sensor, and a controller in communication with the temperature sensor, the cooktop comprising a heating element, the heating element comprising an induction coil, the method comprising:
performing, by the controller, a cooking operation, the cooking operation comprising activating the heating element of the induction cooking appliance;
monitoring a temperature with the temperature sensor during the cooking operation; and
operating the cooling fan based on the monitored temperature.

2. The method of claim 1, wherein, when operating the cooling fan, the cooling fan is operated at a specified fan speed, the specified fan speed is based on the monitored temperature.

3. The method of claim 1, further comprising deactivating the heating element of the induction cooking appliance in response to the monitored temperature being above a threshold temperature value.

4. The method of claim 1, further comprising determining an active state condition of the induction coil, wherein operating the cooling fan is further based on the active state condition of the induction coil.

5. The method of claim 4, wherein determining the active state condition comprises determining whether the induction coil is one of ON or OFF.

6. The method of claim 1, further comprising determining a power level condition of the induction coil, wherein operating the cooling fan is further based on the power level condition of the induction coil.

7. The method of claim 6, wherein determining the power level condition comprises determining the induction coil is operating at a specified power level during the cooking operation.

8. The method of claim 1, wherein the monitored temperature during the cooking operation is indicative of a temperature of a switching device positioned on a heat sink.

9. The method of claim 8, wherein operating the cooling fan comprises forcing airflow over the heat sink.

10. An induction cooking appliance, comprising:
a cooktop comprising a heating element, the heating element comprising an induction coil;
a cooling fan;
a temperature sensor; and
a controller in communication with the temperature sensor, the controller configured to:
perform a cooking operation, the cooking operation comprising activating the heating element of the induction cooking appliance;
monitor a temperature with the temperature sensor during the cooking operation; and
operate the cooling fan based on each of the determined active state condition of the induction coil, the determined power level condition of the induction coil, and the monitored temperature of the temperature sensor.

11. The induction cooking appliance of claim 10, wherein the controller is configured to operate the cooling fan at a specified fan speed, the specified fan speed is based on the monitored temperature.

12. The induction cooking appliance of claim 10, wherein the controller is configured to deactivate the heating element of the induction cooking appliance in response to the monitored temperature being above a threshold temperature value.

13. The induction cooking appliance of claim 10, wherein determining the active state condition comprises the controller configured to determine whether the induction coil is one of ON or OFF.

14. The induction cooking appliance of claim 10, wherein determining the power level condition comprises the controller configured to determine the induction coil is operating at a specified power level during the cooking operation.

15. The induction cooking appliance of claim 14, wherein operating the cooling fan is based on the specified power level of the induction coil during the cooking operation.

16. The induction cooking appliance of claim 10, wherein the temperature monitored during the cooking operation is indicative of a temperature of a switching device positioned on a heat sink.

17. The induction cooking appliance of claim 16, wherein operating the cooling fan comprises forcing airflow over the heat sink.
